(19) United States
(12) Patent Application Publication
(10) Pub. No.: US 2004/0177725 A1
(43) Pub. Date: Sep. 16, 2004

(54) Socket replaceable ratchet wrench

(76) Inventor: Chen Shih-Yueh, Da-Li City (TW)

Correspondence Address: CHARLES E. BAXLEY, ESQUIRE, Third Floor, 90 John Street, New York, NY, 10038, US

(21) Appl. No.: 10/616,756

(22) Filed: Jul. 9, 2003

(30) Foreign Application Priority Data
Mar. 13, 2003 (TW) 0922014179

(51) Int. Cl. B25B 13/46

(52) U.S. Cl. 81/63.1

(57) ABSTRACT

A socket replaceable ratchet wrench generally comprises a base body of the wrench, in which a pair of pawls, a control rod, a force block, an oscillating piece and a socket. The timely engagement and disengagement between the pawls and the socket can be accomplished by virtue of the cooperation between the control rod and the oscillating piece so as to provide an effect of multipurpose. In addition, by taking advantage of the conical surface of the force block to enable the two pawls to move along it and then force the same to disengage from the teeth of the socket, such that socket can be removed and replaced.

### BACKGROUND OF THE INVENTION

1. Field of the Invention

The present invention relates to a socket wrench, and more particularly to a socket replaceable ratchet wrench.

2. Description of the Prior Arts

The ratchet socket wrench is one of the commonest hand tools which have been applied in a wide range, the structures of which are much varied. Thereby it is an important object to develop a simple structured ratchet applicable to different sized work pieces.

Due to a ratchet wrench is only applicable to single sized work piece (such as screw nut, bolt), thereby in real operation a number of different sized ratchet wrenches are required for ensuring a successful operation, obviously which lacks of applicability and much inconveniences will be caused accordingly.

As shown in FIG. 9, a conventional ratchet socket wrench generally includes a base body 80, a ratchet member 81, a socket 82 and a retainer 83. However, there are some disadvantages will be caused and need to be improved in real operation:

First, the socket 82 has a first end 821 to be engaged in the receiving hole 811 of the ratchet member 81 and a second end 822 for engaging with the work piece so as to perform a driving operation. However, due to the second end 822 protrudes out of the receiving hole 811 of the ratchet member 81, which increases the unnecessary working space of the ratchet socket wrench and decreases the applicability of the same.

Second, due to both the engaging hole of the socket 82 and the first end 821 of the socket 82 are special formed, the replaceable possibility of which is limited (which can not be easily and widely replaced).

Third, due to the engaging hole of the socket 82 is slot-shaped having a closed end, which is only applicable to fastening pieces of a single system (English or Metric system dimensioned fastening pieces), the applicability of conventional ratchet socket wrench is weak.

The present invention has arisen to mitigate and/or obviate the afore-described disadvantages of the conventional ratchet socket wrench.

### SUMMARY OF THE INVENTION

In accordance with one aspect of the present invention, there is provided with a socket replaceable ratchet wrench which generally comprises a base body, in which a pair of pawls, a control rod, a force block, an oscillating piece and a socket are disposed respectively. The timely engagement and disengagement between the pawls and the socket can be accomplished by virtue of the cooperation between the control rod and the oscillating piece so as to provide an effect of multipurpose. In addition, by taking advantage of the conical surface of the force block to enable the two pawls to move along it for purpose of forcing the same to disengage from the teeth of the socket, such that socket can be removed and replaced.

The primary object of the present invention is to provide a socket replaceable ratchet wrench, which is capable of replacing sockets for different sizes by virtue of a single ratchet socket wrench so as to improve the applicability of the same.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of a ratchet socket wrench in accordance with the present invention;

FIG. 2 is a cross-sectional view of the ratchet socket wrench in accordance with the present invention;

FIG. 3 is another cross-sectional view of the ratchet socket wrench in accordance with the present invention;

FIG. 4 is an illustrative view in accordance with the present invention of illustrating the principle of replacing the socket;

FIG. 5 is a second illustrative view in accordance with the present invention of illustrating the principle of replacing the socket;

FIG. 6 is a third illustrative view in accordance with the present invention of illustrating the principle of replacing the socket;

FIG. 7 is a fourth illustrative view in accordance with the present invention of illustrating the principle of replacing the socket;

FIG. 8 is a cross-sectional view of a triple-section ratchet in accordance with the present invention;

FIG. 9 is an exploded view of a conventional ratchet socket wrench.

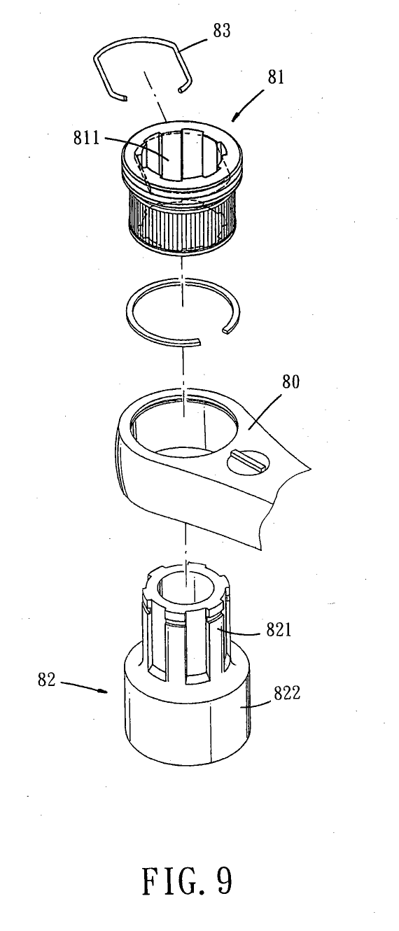

### DETAILED DESCRIPTION OF THE PREFERRED EMBODIMENT

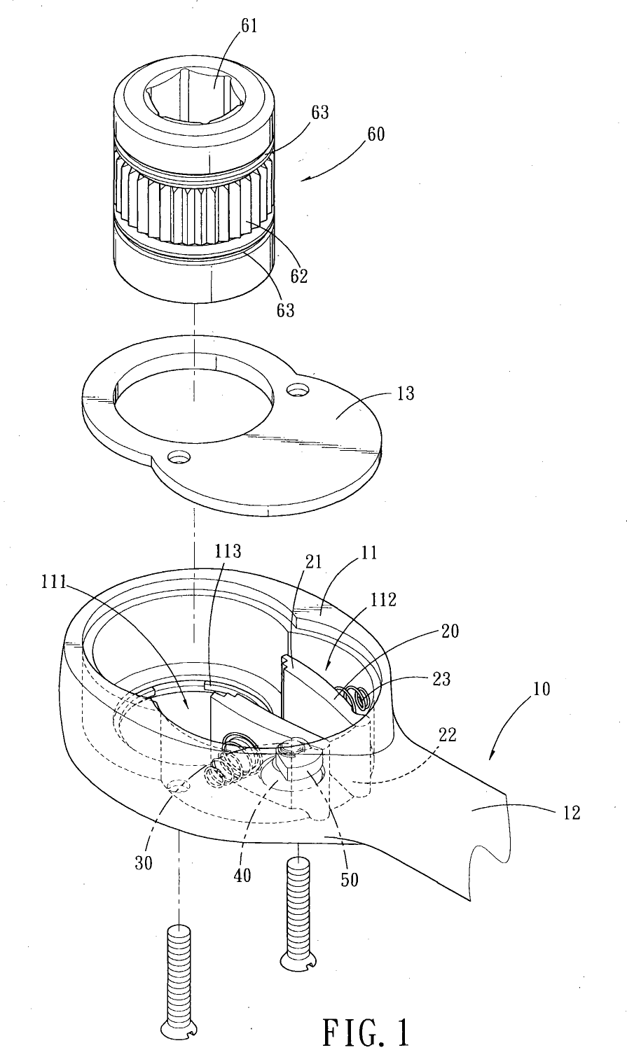

Referring to FIGS. 1,2,5,8, a socket replaceable ratchet wrench in accordance with the present invention generally comprises a base body 10, a pair of pawls 20, a control rod 30, a force block 40, an oscillating piece 50 and a socket 60.

The base body 10 including a head portion 11 and a handle portion 11, wherein the head portion 11 has a receiving hole 111 covered with a cover 13, the receiving hole 11 communicates with a chamber 112. While on the inner wall of the receiving hole 11 a resilient ring member 113 is disposed, the handle portion 12 is provided for the user's holding.

The pair of pawls 20, each of which is provided with an engaging portion 21 at a first end and a coupling portion 22 at a second end. The two pawls 20 are oppositely and correspondingly disposed in the chamber 112 of the base body 10 by virtue of the coupling portions 22. Between the outer side of each pawl 20 and the inner wall of the chamber 112 a resilient member 23 (such as spring) is biased respectively. After the pawls 20 are under control, the engaging portions 21 of each of which 21 can timely protrude in the receiving hole 111 of the base body 10.

The control rod 30 is hexagonal shaped in cross section, which has a pushing portion 31 defined at an end. The control rod 30 is pivotably disposed in the chamber 112 of the base body 10 and located between the two pawls 20 with the pushing portion 31 protruding out of the head portion 11 of the base body 10. Between the pushing portion 31 and the head portion 11 of the base body 10 a resilient member 32 (such as spring) and a turning member 33 are disposed respectively. Wherein the resilient member 32 serves for enabling the pushing portion 31 to return to original position after it is pushed, while the turning member 33 serves to effect synchronous movement of the control rod 30.

The force block 40 is provided with a conical surface 41and fixed to the control rod 30, which moves synchronously with the control 30. The conical surface 41 is corresponding to the sides of the two pawls 20. The two pawls 20 move along the slope of the conical surface 41 by pushing the control rod 30 so as to force the engaging portions 21 of the two pawls 20 to move into the chamber 112 of the base body 10.

The oscillating piece 50, a flat member having unequal diameters, is fixed to the control rod 30 and moves synchronously with the same and located between the corresponding surfaces 24 of the two pawls 20 with the periphery of which abutting against the corresponding surfaces 24 of the two pawls 20. By rotating the control rod 30, the two pawls 20 will be pushed by the oscillating piece 50 and the engaging portions 21 of which will protrude in the receiving hole 111 of the base body 10.

The socket 60 is provided at both ends with a different sized receiving hole 61 respectively, at the periphery of which a plurality of teeth 62 and an annular groove 63 corresponding to the resilient ring member 113 are defined respectively. The socket 60 is removably received in the receiving hole 111 of the base body 10 with the teeth 62 engaging with the engaging portions 21 of the two pawls 20, further with the resilient ring member 113 engaged in the annular groove 63, such that increase the stability of the engagement between the socket 60 and the base body 10.

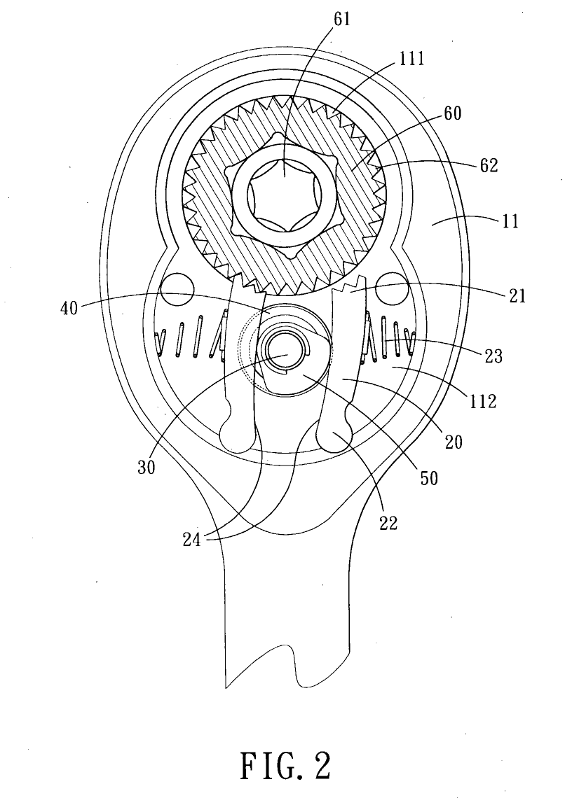

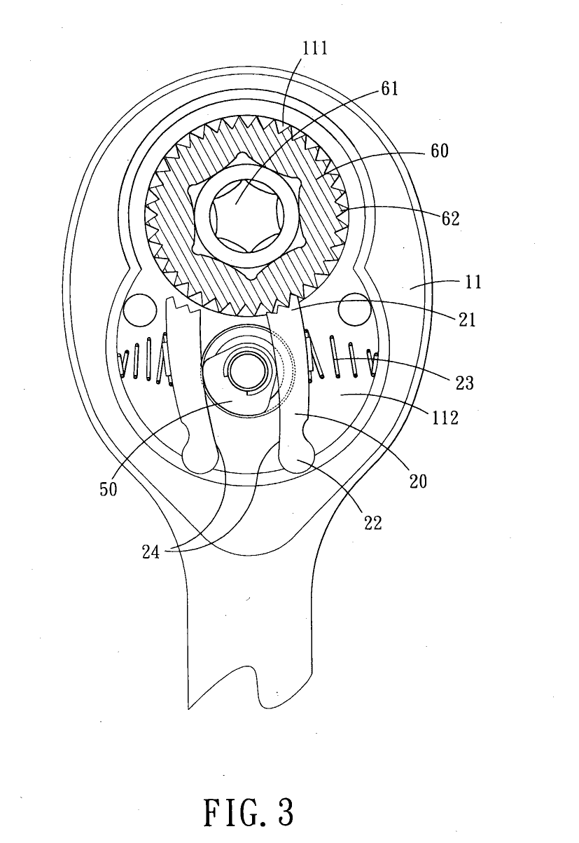

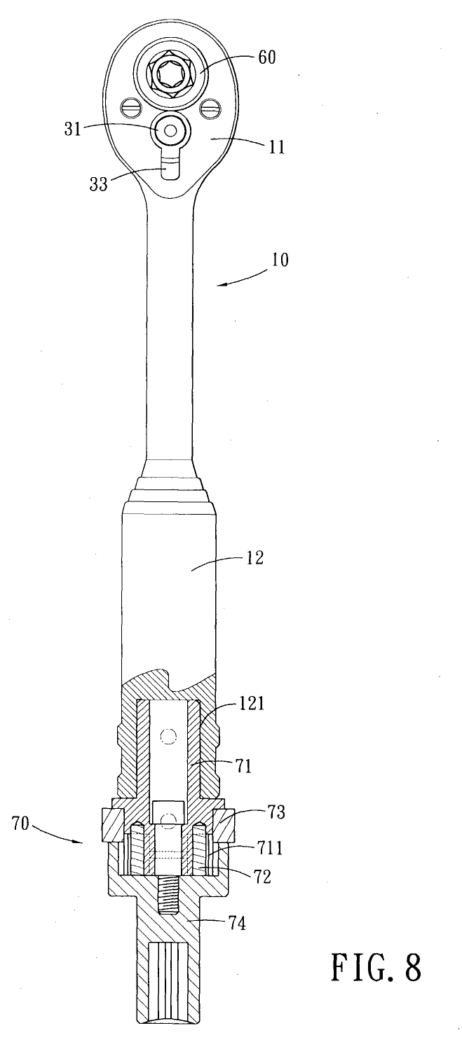

Referring further to FIGS. 2-3, in which, the corresponding surfaces 24 abut against the periphery of the oscillating piece 50 due to the two pawls 20 are pushed by the resilient member 23. In this case, the user can turn the turning member 33 (with referring to FIG. 8) left or right to effect synchronous movement of the oscillating member 50, while the oscillating member 50 pushes the two pawls 20 to move, such that enable the engaging portions 21 of the two pawls 20 timely to protrude in the receiving hole 111 of the base body 10. In other words, the engaging portions 21 of the two pawls 20 timely engage with the teeth 62 of the socket 60 along with the left and right turn of the turning member 33, which accordingly effects clockwise or counterclockwise revolution of the socket 60.

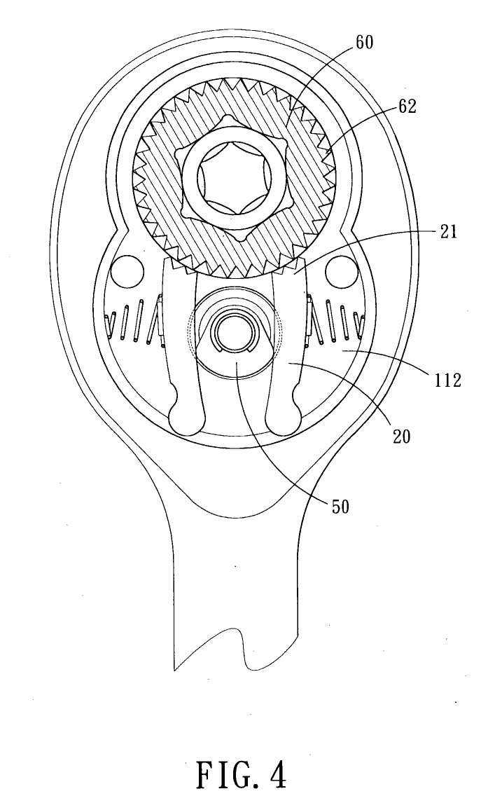

Referring now to FIG. 4, in case that the user wants to replace the socket 60 with different sizes or forms, what he needs to do is returning the turning member 33 (with referring to FIG. 8) back to original position, by pushing the outer edge of the oscillating member 33 the engaging portions 21 of the two pawls 20 can be pushed into the chamber 112 of the base body 20. At the moment, the engaging portions 21 of the two pawls 20 disengaged from the teeth 62 of the socket 60, thereby the socket 62 can be replaced.

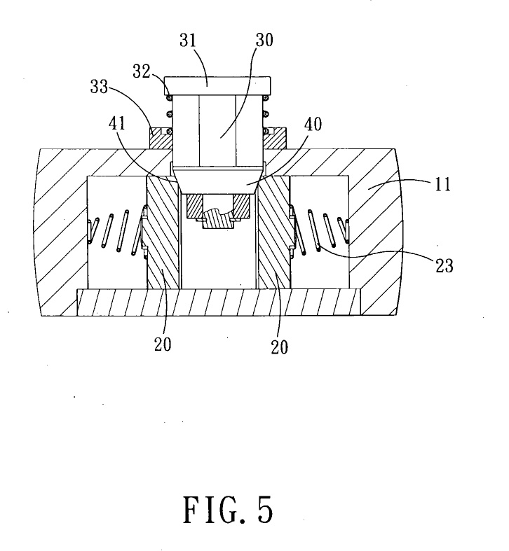

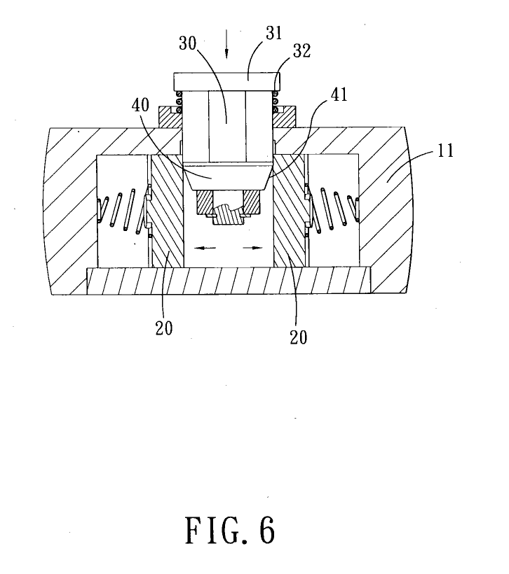

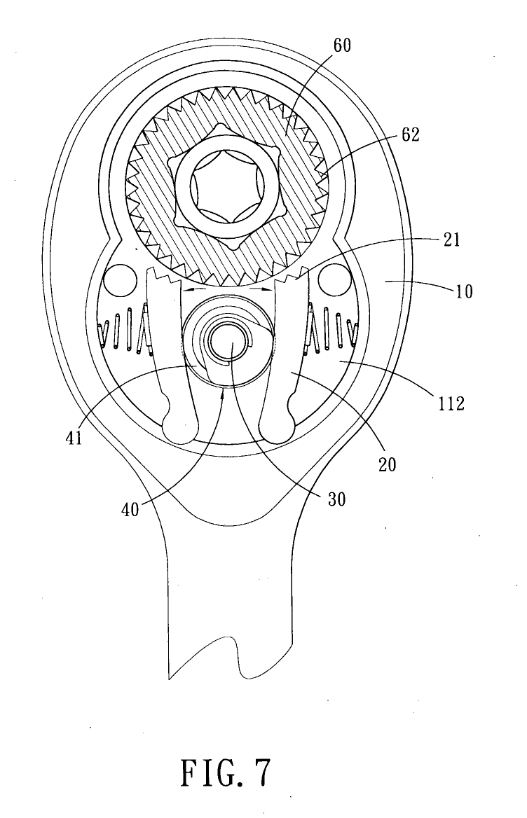

Referring to FIGS. 5-7, in which, the user also can push the pushing portion 31 of the control rod 30 to effect synchronous movement of the force block 40, thus the two pawls 20 move along the slope of the conical surface 41 of the force block 40 to push the engaging portions 21 of the two pawls 20 into the chamber 112 of the base body 10 and accordingly disengaged from the teeth 62 of the socket 60. Thereby the socket 60 can be replaced. Just by pushing the pushing portion 31 of the control rod 30 the socket 60 can be replaced, such that simplify the processes of replacing the socket 60.

For simplifying the description, the two socket-replacing manners is described above in an unified manner, but in real manufacturing, the manufacturer can take one of the two replacing manners alternatively.

Referring finally to FIG. 8, the socket replaceable ratchet wrench of the present invention is provided at an end of the handle portion 12 of the base body 10 with a slot 121, in which a triple-section ratchet 70 is received. The triple-section ratchet 70 includes a central rod 71, a pair of blocks 72, a control ring 73 and a cap 74. The control rod 71 defines a gap 711 at both side thereof for the receipt of the blocks 72 respectively, while taking advantage of the control ring 73 to control the oscillating angle of the two blocks 72 such that enables the ratchet to revolve clockwise, counterclockwise or accomplish bi-directional stoppage.

While we have shown and described various embodiments in accordance with the present invention, it should be clear to those skilled in the art that further embodiments may be made without departing from the scope of the present invention.

What is claimed is:

1. A socket replaceable ratchet wrench comprising:
a base body having a head portion and a handle portion, the head portion being provided with a receiving hole and a chamber in communicating with the receiving hole;
a pair of pawls each provided at an end with an engaging portion, the two pawls received in the chamber of the base body and each portion capable of timely protruding in the receiving hole of the base body of the wrench;
a control rod having a pushing portion defined at an end, which received in the chamber of the base body and located between the two pawls with the pushing portion protruding out of the base body, the pushing portion being able to return to the original position after being pushed;
a force block having a conical surface and fixed to the control rod, the conical surface corresponding to the sides of the two pawls;
an oscillating piece fixed to the control rod and the periphery of which contacting the corresponding surfaces of the two pawls;
a socket provided at both ends with a different sized receiving hole respectively, at the periphery of which a plurality of teeth being defined, the socket removably received in the receiving hole of the base body with the teeth engaging with the engaging portions of the two pawls;
by such a manner, the conical surface of the force block effecting synchronous movement of the two pawls whereby force the two pawls to disengage from the teeth of the socket, thus enabling the replacement of sockets for different sizes.

2. The socket replaceable ratchet wrench as claimed in claim 1, wherein resilient ring is disposed on the inner wall of the receiving hole of the base body, while the socket is provided with an annular groove with corresponding to the resilient ring, whereby to enforce the stability of engagement between the base body and the socket.

3. The socket replaceable ratchet wrench as claimed in claim 1 further comprising a resilient member biased between the pushing portion of the control rod and the base body for enabling the pushing portion to return to original position automatically.

4. The socket replaceable ratchet wrench as claimed in claim 3, wherein the resilient member is a spring.

5. The socket replaceable ratchet wrench as claimed in claim 1 further comprising a turning member disposed on the pushing portion of the control rod which effects synchronous movement of the oscillating piece.

6. The socket replaceable ratchet wrench as claimed in claim 1 further comprising a slot defined in the handle portion of the base body and in which a triple-section ratchet is received.

7. The socket replaceable ratchet wrench as claimed in claim 6, wherein the triple-section ratchet includes a central rod, a pair of blocks, a control ring and a cap, the control rod defining a gap at both sides thereof for the receipt of the two blocks respectively, while taking advantage of the control ring to control the oscillating angle of the two blocks for enabling the ratchet to revolve clockwise, counterclockwise or bi-directional stoppage.
